(19) United States
(12) Patent Application Publication
(10) Pub. No.: US 2013/0165154 A1
(43) Pub. Date: Jun. 27, 2013

(54) METHOD AND DEVICE FOR AUTOMATIC CHECK-IN AT BUSINESSES AND OTHER APPROPRIATE VENUES USING HANDHELD DEVICES

(71) Applicant: Shrinivas B. Joshi, Austin, TX (US)

(72) Inventor: Shrinivas B. Joshi, Austin, TX (US)

(73) Assignee: ADVANCED MICRO DEVICES, INC., Sunnyvale, CA (US)

(21) Appl. No.: 13/418,753

(22) Filed: Mar. 13, 2012

Related U.S. Application Data
(60) Provisional application No. 61/578,450, filed on Dec. 21, 2011.

(51) Int. Cl. H04W 4/02

(52) U.S. Cl. 455/456.3

(57) ABSTRACT

A method and system for automatically checking-in patrons by detecting that a user is within a defined boundary and then communicating with the patron to invite them to electronically check-in with a business via a mobile device.

### RELATED APPLICATION

This application claims priority to the provisional patent application having Application No. 61/578,450, filed on Dec. 21, 2011, having inventor Shrinivas Joshi, titled “METHOD AND DEVICE FOR AUTOMATIC CHECK-IN AT BUSINESSES AND OTHER APPROPRIATE VENUES USING HANDHELD DEVICES”, owned by instant assignee which is hereby incorporated herein by reference in its entirety.

### FIELD OF THE DISCLOSURE

The present disclosure is related to automated methods and devices for allowing proximity based automatic registration.

### BACKGROUND

Businesses such as restaurants, health clinics, spas, airports, meeting spaces, and others often have a process by which customers or attendees register with the business. The registration process often places registrants within a list that is then used to determine access to resources of the business. For restaurants, the resource may be seating. For health clinics, the resource may be a room or a healthcare professional. Registration may take place by in-person communication, over the phone, over the internet, or otherwise. For registration other than in-person registration, once a registrant arrives at a business the registrant is often required to follow up and check-in in-person at the business location.

Whereas the registration process has adapted to incorporate means and processes other than in-person registration, the follow-up process of checking-in has continued to require in-person communication or interaction with a dedicated kiosk. Such in-person or kiosk based check-in provides added cost through labor costs or device acquisition and maintenance costs. Additionally, such in-person or kiosk based check-ins provide a limited number of check-in locations that can provide a restriction to the efficient use of resources.

Accordingly, there exists a need for an improved method and apparatus that automates the check-in process while still providing assurance of the physical presence of the registrant at the business location and while reducing the restrictions provided by having a limited number of check-in locations.

### BRIEF DESCRIPTION OF THE DRAWINGS

FIG. 1 is a diagrammatic view of computing entities employed in accordance with an embodiment of the present disclosure;

FIG. 2 is a diagrammatic view of communications employed between the computing entities of FIG. 1 in accordance with an embodiment of the present disclosure;

FIG. 3 is a diagrammatic view of an embodiment of geographic positioning of the computing entities of FIG. 1;

FIG. 4 is an exemplary view of a screen of the mobile computing entity of FIGS. 1; and

FIG. 5 is a flow chart showing the method of the communication of FIG. 2 from the perspective of the publisher apparatus of FIG. 1.

### DETAILED DESCRIPTION

Briefly, in one example, a method is provided. The method includes establishing a geographic location boundary associated with a provider. A publisher device then determines that a mobile attendee device is located within the location boundary. Based on the determination that the mobile attendee device is located within the location boundary, communication is automatically transmitted from the publisher device to the mobile attendee device to invite an attendee to register with the provider. In response to the automatically transmitted communication, attendee information is received from the mobile attendee device. The attendee information is then transmitted to a computing device associated with the provider.

In another example, a device for interacting with an attendee is provided. The device includes a processor, at least one communication device coupled to the processor, and a memory coupled to the processor and containing instructions. The instructions, when interpreted by the processor, cause the device to receive registration information from a client via the at least one communication device; determine a boundary associated with a physical client location; determine that an attendee device is located within the boundary; automatically transmit communication to the attendee device via the at least one communication device, the communication including client identifying information, receive attendee information from the attendee device via the at least one communication device; and transmit the attendee information such that the attendee information is received by a client device located within the boundary.

Among other advantages, for example, the method and device provide for automatic location based check-in at a business or other location. The check-in is achieved without taking up time of a business employee and without requiring the investment and space required for on-site dedicated customer-facing check-in computing devices. The method also provides the advantage of assuring that the customer checking in is located proximate to the business. The method also provides the advantage that a larger area can be used for check-in as opposed to traditional methods where all customers are required to go to a limited area (such as a hostess stand) to check-in. The method provides that more numerous check in areas can be provided without additional staff (e.g., back entrances, front entrances, entrances from underground, etc.). The method provides for greater throughput using existing physical resources. The method provides for registration materials/information/questionnaires to be immediately transmitted to a customer checking in (e.g., conference materials, medical questionnaires, etc.). The method makes it possible to register for multiple services simultaneously—e.g., checking into a hospital can register you with the payment office, the emergency room and phone/TV service provider; checking into a hotel based conference can register you with the hotel, conference provider and sign you up or allow choices of optional lunches/events. The method also provides that check-in is achieved through a written interface. A written interface can sometimes be easier to perceive than a spoken interface. Thus, the method can reduce or eliminate language barriers.

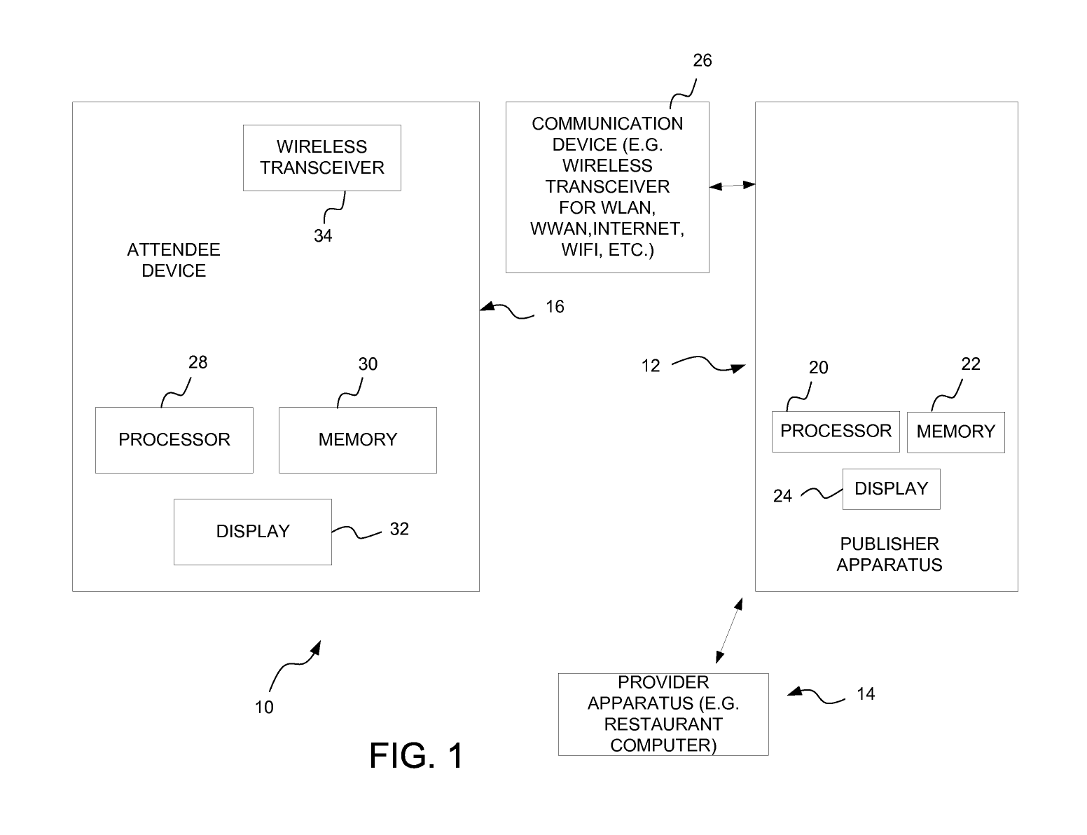

Turning now to the drawing wherein like numerals represent like components, FIG. 1 is a diagram of a system 10 that provides for automated check-in of individuals or groups. System 10 includes publisher apparatus 12, a provider apparatus 14, and a plurality of mobile devices 16. Publisher apparatus 12 includes processor 20, memory 22 accessible by processor 20, display 24, and wireless transceiver 26. Publisher apparatus 12 further includes an input/output device (not shown) such as an Ethernet card that provides for communication with provider apparatus 14.

Provider apparatus 14 is illustratively a personal computer located at a restaurant running restaurant management software thereon (including reservation management services). Other embodiments are envisioned where provider apparatus 14 is running other software specific to its particular location. Such locations include but are not limited to medical clinics, movie theaters, spas, airports, and convention/meeting space. Mobile device 16 is provided as a smart phone, tablet, or other mobile device, the location of which can be communicated to or determined by devices remote to mobile device 16 (such as publisher apparatus 12). Mobile device 16 includes processor 28, memory 30, display 32, and wireless transceiver 34.

Publisher apparatus 12 includes one or more processors that execute software for coordinating and effecting check-in of an attendee (someone who is attending a location) with the provider. It should be appreciated that while publisher apparatus 12 is shown as being distinct and separate (both physically and geographically) from provider apparatus 14, embodiments are envisioned where the pieces, software, and function of publisher apparatus 12 are present in provider apparatus 14. Embodiments are also envisioned where publisher apparatus 12 is a distinct apparatus that is co-located with provider apparatus 14.

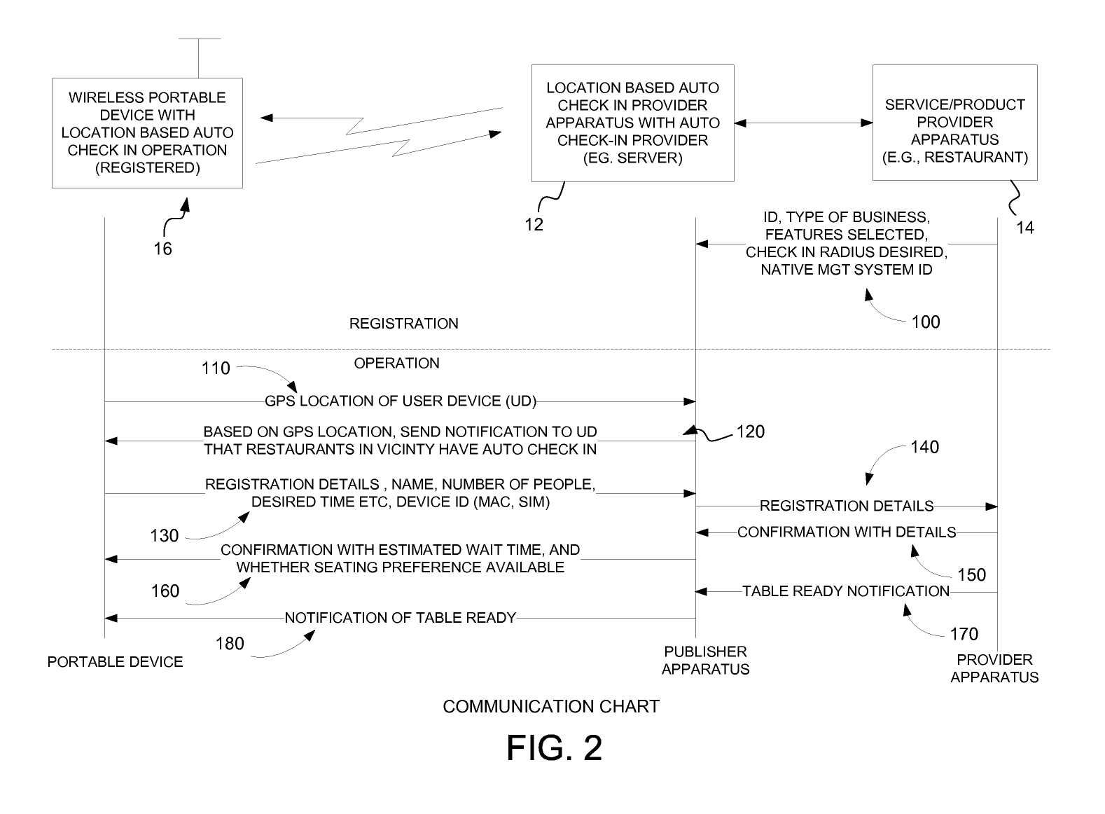

The one or more processors on publisher apparatus 12 maintains a database of providers that subscribe to its service in memory 22. As shown in FIGS. 2 & 5, providers register with publisher apparatus 12, (FIGS. 2 & 5, 100) by sending provider identification/registration information, such as a unique provider number, which is received by publisher apparatus 12. The provider also identifies itself by the type of provider it is. In one embodiment, the type of provider is ascertainable from the provider identification information submitted and from provider information already present at publisher apparatus 12.

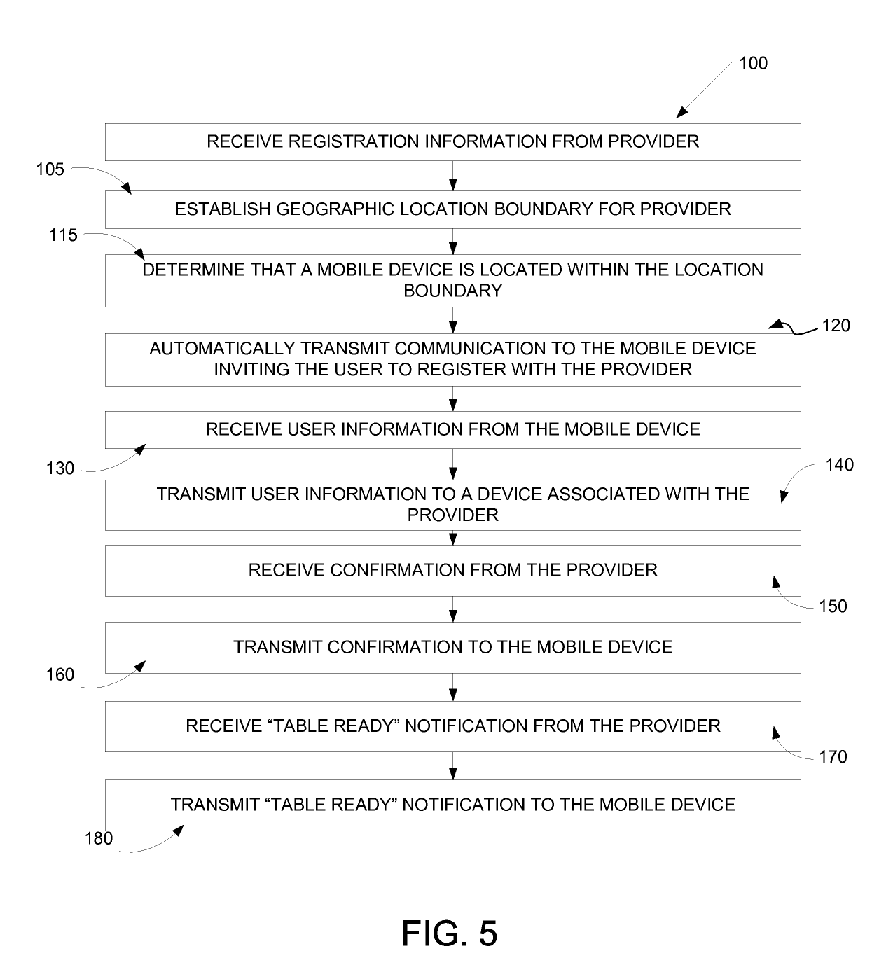

During registration, provider apparatus 14 also provides an indication of which features offered by publisher apparatus 12 are desired. Offered features depend partially on the type of entity that the provider identifies itself as. Provider apparatus 14 also indicates the location of the provider 36 and defines a radius distance 38. The radius distance 38 and location are used by publisher apparatus 12 to define/establish a geographic location boundary 39 where mobile devices 16 are required to be located to be able to utilize the check-in service for the specific provider. (FIG. 5, 105) Mobile devices 16 can transmit its GPS based coordinates to allow location thereof. Alternatively, cell phone receivers and/or WiFi transmitters can be used to triangulate a location of mobile devices 16. Registration of provider apparatus 14 further includes identification of the software program being used by the provider to manage their check-in process.

In one embodiment, users at the provider use a program on provider apparatus 14 to log in and out or turn on and off the functionality of the software on publisher apparatus 12 with respect to their provider. In other embodiments, hours of operation are also provided to publisher apparatus 12 such that turning off and on of the functionality is automated.

Mobile devices 16 are provisioned at the device level, application level, or any other way to accept incoming transmissions generated by publisher apparatus 12. In one embodiment, mobile device 16 is set to accept push notifications from publisher apparatus 12. If needed, mobile device 16 also grants permission for publisher apparatus 12 to receive location information about mobile device 16. Mobile devices 16 thus provide location information, via GPS or otherwise, to publisher apparatus 12 (FIG. 2, 110). Embodiments are envisioned where permission to accept push notifications and to provide location information are performed via an application provided by the publisher or provided by the provider. Embodiments are envisioned where a customer initially signs up such that the MAC address or IMSI of mobile device 16 is provided to publisher apparatus 12.

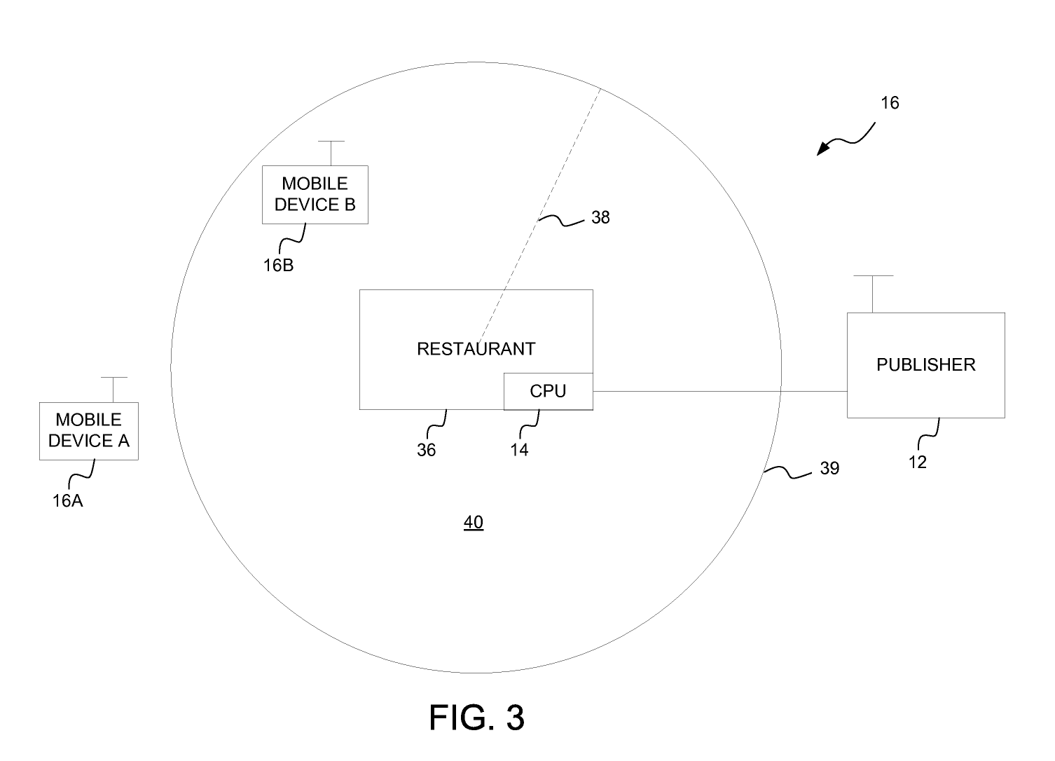

Publisher apparatus 12 takes data provided by provider apparatus 14 regarding location of the provider and radius distance 38 and establishes zone 40, bounded by geographic location boundary 39, FIG. 3. While zone 40 is shown as a circle, it should be appreciated that embodiments are envisioned where boundaries are defined by coordinates or other ways other than a circle with a radius. In one embodiment, the boundary is defined to cooperate with geographic features in the vicinity of the provider.

Publisher apparatus 12 monitors mobile devices 16 and zone 40 to find mobile devices located within zone 40. Embodiments are envisioned where publisher apparatus 12 monitors a list of mobile devices 16 to determine when one of them is within zone 40 and within the geographic location boundary 39 (FIG. 5, 115). Embodiments are envisioned where publisher apparatus instead monitors zone 40 to determine if mobile device 16 enters. Still other embodiments are provided where a signal is broadcast in zone 40 and geographic location boundary 39 is defined by the signal strength of the broadcast. Embodiments are further envisioned where upon initial registration, publisher apparatus 12 provides a geographical delineated zone via GPS coordinates to mobile device 16. Mobile device 16 monitors its GPS location and broadcasts its location when it enters the previously received zone coordinates during the appointed times (e.g., transmits its unique identifier and perhaps a key provider by the publisher upon signing up to the conference/resource). Publisher apparatus 12, during the appointed times and in the previously provided zone, listens for the customer's unique identifier (and/or key previously provided by the publisher).

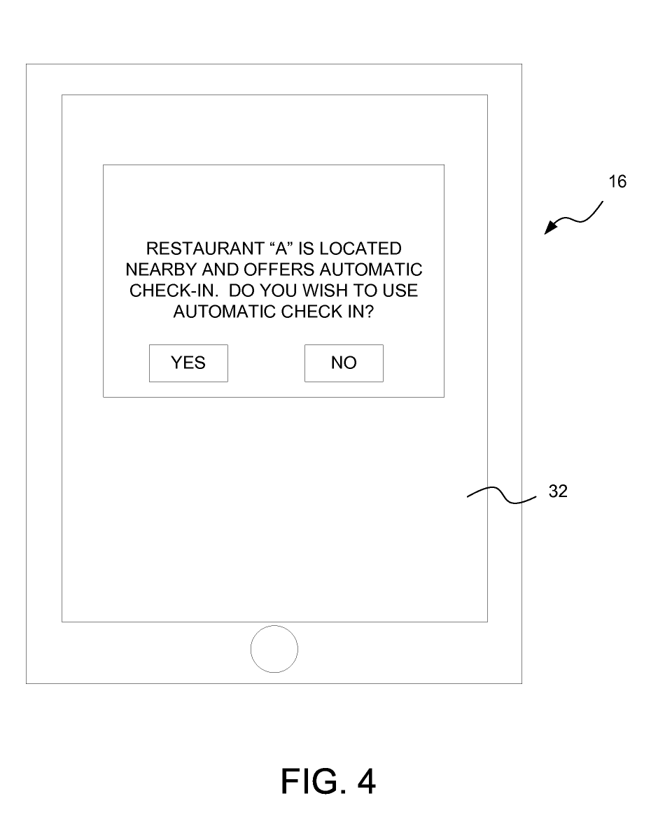

Upon determination that mobile device 16 of an attendee is within geographic location boundary 39, such as mobile device B 16b, a communication is automatically transmitted to mobile device B 16b that invites the attendee to register with the provider and provider apparatus 14. (FIGS. 2 & 5, 120). The communication, when received by wireless transceiver 34 of mobile device 16, interacts with processor 28 and presents a notification on display 32. An exemplary notification is provided in FIG. 4. Affirmative responses by the attendee prompt the attendee to enter registration details. Examples of registration details are name, number of people in the party, number of tickets desired, seating preference, and desired reservation time. These registration details, user information, are then transmitted by mobile device 16 and received by publisher apparatus 12. (FIGS. 2 & 5, 130). Embodiments are also envisioned where information identifying the mobile device 16, such as mac addresses, sim card identifiers (ID's), or otherwise are also transmitted.

The registration details (user information) are then transmitted to a device associated with the provider such as provider apparatus 14. (FIGS. 2 & 5, 140). More specifically, the registration details are provided such that the information is able to be incorporated into a program being run on provider apparatus 14 that manages the service that the attendee is registering for such as a queue to manage seating in the restaurant.

Once the registration details are received by provider apparatus 14 and merged into the management system thereon, a confirmation is issued by provider apparatus 14 and received by publisher apparatus 12 (FIGS. 2 & 5, 150). Publisher apparatus 12 then transmits the confirmation to mobile device 16 (FIGS. 2 & 5, 160). The confirmation illustratively includes information regarding estimated wait time and availability of seating preference.

Subsequently, when the attendee's table is available (such as when his party has progressed to the front of the queue) provider apparatus 14 issues a notification to that effect that is received by publisher apparatus 12 (FIGS. 2 & 5, 170). Publisher apparatus 12 then transmits the notification to mobile device 16 (FIGS. 2 & 5, 180).

Exemplary use from the perspectives of the various participants will now be described below. The perspective of publisher apparatus 12 is largely described above and will not be repeated.

Provider:

The provider (for purposes of this example, a restaurant) has a computer 14 implemented reservation system. The restaurant reservation system takes reservations via input of an employee (from in-person interactions with customers, over the phone interactions, or otherwise), via customer direct entry over the internet, or otherwise. The reservation system further has a table listing that includes customer capacity information. The reservation system may also include order entry and billing services.

The provider engages the publisher and arranges for the reservation system on provider apparatus 14 to interface with to auto-check in software on publisher apparatus 14. This may involve obtaining software, such as an “add-in” module for their existing reservation system. The software (when executing) on the provider apparatus 14 is used to send configuration information to publisher apparatus 12 (FIGS. 2 & 5, 100).

The provider apparatus 14 then receives reservation information via the traditional routes. Employees of provider also interact with provider apparatus 14 to provide indications that parties have physically checked-in with a hostess at the restaurant.

The reservation system on provider apparatus 14 constantly updates with new parties in new reservations entered manually, via an internet based reservation interface, via the presently disclosed auto-check-in system, or otherwise. Reservations and check-ins can be taken by the reservation system (FIGS. 2 & 5, 140), and confirmations sent (FIGS. 2 & 5, 150), without any actions being taken by the employees.

The check-in status of the parties is constantly updated via traditional manual check-ins or via the presently disclosed auto-check-in system. In one embodiment, indications are provided to show the manner in which a party has checked in (manual, auto-check-in, or otherwise).

As tables become available, provider employees interact with the reservation system to indicate parties that have been seated. Seated parties are taken out of the queue and optionally assigned to a table in provider apparatus 14. Removal of seated parties from the queue allows other checked-in parties to progress up the queue.

When a party's table is available, an employee can announce the party's name to ask them to come forward. Alternatively, the employee can activate a pager system to activate a token given to the party, if such tokens are used. The software on provider apparatus 14 can be integrated with the pager system such that selecting a party on provider apparatus 14 automatically activates the token.

However, for parties using the auto-check-in system, the party didn't need to visit the hostess to check-in, and thus did not have opportunity to obtain a token. Thus, the software on provider apparatus 14 instead issues a directive to publisher apparatus 12 to notify mobile device 16 that the restaurant is ready to seat the party. Embodiments are envisioned where the steps taken to activate a token and to notify mobile device 16 are the same such that the provider employee is ignorant as to which is being performed. Other embodiments are envisioned where the steps are the same, but the provider employee knows which of a token or mobile device 16 are being notified, so that the provider employee knows whether to expect to retrieve a token from the party. The provider employee then notes in provider apparatus 14 that the party was seated and the queue is further processed.

Customer:

Having received configuration information from provider apparatus 14, publisher apparatus 12 establishes zone 40, within geographic location boundary 39. Publisher apparatus then monitors zone 40 and/or provisioned mobile devices 16 to discover any properly provisioned mobile devices 16 within zone 40.

Two types of customer are now discussed. The first customer is one who has previously registered with the provider. In the embodiment of a restaurant, the first customer is one who has previously made a reservation. The previous interaction provides the opportunity to specifically provision the user's mobile device 16 to accept messages from the provider via publisher apparatus 12. The second customer is one who has not previously registered with the provider, but has generally provisioned the user's mobile device 16 to receive messages from establishments generally.

Each of the first and second customers have enabled their mobile devices 16 to share location information. Such location information is therefore shared (FIGS. 2 & 5, 110). Mobile devices 16, specifically those such as mobile device A 16A, located outside of zone 40 (beyond geographic location boundary 39) do not receive messages availing them of the auto-check-in functionality of publisher apparatus 12. As devices cross geographic location boundary 39 into zone 40, or as devices are powered on within zone 40, such as mobile device B 16B, the location information is sent by mobile device 16 (directly or indirectly) to publisher apparatus. Mobile device 16B then receives a notice that the restaurant is in the vicinity and is offered the opportunity to automatically check-in (FIGS. 2 & 5, 120; FIG. 4).

The user of the mobile device 16B, either the first customer or the second customer, then responds in the affirmative and sends registration details (FIGS. 2 & 5, 130). For the first customer, the specific provisioning can permit that the registration details are either already known by provider apparatus 14 or already known within mobile device 16. For the second customer, it is more likely that at least some of the registration details will need to be input at the mobile device 16B. The customer then receives a confirmation (FIGS. 2 & 5, 160). Subsequently, mobile device 16B receives an indication that the restaurant is ready to seat the customer.

The above detailed description and the examples described therein have been presented for the purposes of illustration and description only and not for limitation. For example, the operations described may be done in any suitable manner. The method steps may be done in any suitable order still providing the described operation and results. It is therefore contemplated that the present embodiments cover any and all modifications, variations or equivalents that fall within the spirit and scope of the basic underlying principles disclosed above and claimed herein.

What is claimed is:

1. A method including:
establishing a geographic location boundary associated with a provider;
determining that a mobile attendee device is located within the location boundary established by the provider;
based on the determination that the mobile attendee device is located within the location boundary, transmitting communication to the mobile attendee device to invite an attendee user of the mobile device to register with the provider;
receiving attendee information from the mobile attendee device in response to the transmitted communication;
transmitting the attendee information to a computing device associated with the provider.

2. The method of claim 1, further including receiving provider registration information from the provider.

3. The method of claim 2, wherein the registration information includes a provider location and a boundary radius.

4. The method of claim 2, wherein the location boundary is at least partially determined based upon the registration information.

5. The method of claim 1, wherein the automatically transmitted communication identifies the provider.

6. The method of claim 1, wherein the automatically transmitted communication is sent independently of any contemporaneous request by the attendee or a provider representative.

7. The method of claim 1, wherein the automatically transmitted communication invites the attendee to provide information that identifies the attendee.

8. The method of claim 1, wherein transmitting the attendee information allows placing the attendee within a list maintained by a computing device associated with the provider that governs access to a resource of the provider.

9. The method of claim 8, wherein the list is an ordered queue.

10. The method of claim 1, further including:
receiving a confirmation from the computing device associated with the provider and;
transmitting a confirmation to the mobile attendee device.

11. The method of claim 1, further including:
receiving an indication from the device associated with the provider that a provider resource is available for the attendee, and
transmitting an indication that the provider resource is available to the mobile attendee device.

12. The method of claim 1, wherein transmitting the attendee information to a computing device associated with the provider results in the attendee information being provided to a computing device located within the location boundary.

13. A device for interacting with an attendee, the device including:
a processor,
at least one communication device coupled to the processor, and
a memory coupled to the processor and containing instructions, the instructions, when interpreted by the processor, causing the device to:
receive registration information from a provider via the at least one communication device;
determine a boundary associated with a physical provider location;
determine that an attendee device is located within the boundary;
transmit communication to the attendee device via the at least one communication device, the communication including provider identifying information;
receive attendee information from the attendee device via the at least one communication device; and
transmit the attendee information such that the attendee information is received by a provider device located within the boundary.

14. The device of claim 13, wherein the registration information includes a provider location and a boundary radius.

15. The device of claim 13, wherein the boundary is at least partially determined based upon the registration information.

16. The device of claim 13, wherein the automatically transmitted communication is sent independently of any contemporaneous request for the transmission by the attendee or a provider representative.

17. The device of claim 13, wherein transmitting the attendee information allows placing the attendee within a list maintained by a computing device associated with the provider that governs access to a resource of the provider.

18. The device of claim 13, wherein the instructions further cause the device to:
receive a confirmation from the computing device associated with the provider and;
transmit a confirmation to the attendee device.

19. The device of claim 13, wherein the instructions further cause the device to:
receive an indication from the device associated with the provider that a provider resource is available for the attendee, and
transmit an indication that the provider resource is available to the attendee device.

20. The device of claim 19, wherein transmitting the attendee information to a computing device associated with the provider results in the attendee information being provided to a computing device located within the location boundary.
